(19) United States
(12) Patent Application Publication
(10) Pub. No.: US 2020/0106209 A1
(43) Pub. Date: Apr. 2, 2020

(54) Seal Member And Connector Assembly

(71) Applicant: Tyco Electronics Japan G.K., Kawasaki (JP)

(72) Inventors: Yusuke Takahashi, Kawasaki-shi (JP); Tsugumi Matsumoto, Kawasaki-shi (JP)

(73) Assignee: Tyco Electronics Japan G.K., Kawasaki (JP)

(21) Appl. No.: 16/583,760

(22) Filed: Sep. 26, 2019

(30) Foreign Application Priority Data
Sep. 27, 2018 (JP) 2018-181276
Sep. 27, 2018 (JP) 2018-181277

(51) Int. Cl. H01R 13/52

(52) U.S. Cl. CPC H01R 13/5205

(57) ABSTRACT

A seal member includes a main body portion, an easily-deformable portion formed integrally with the main body portion and being more easily deformable than the main body portion, and a pair of lip portions. The lip portions are formed on an outer peripheral side of the seal member in a loading direction in which a compressive load elastically deforming the seal member acts.

### CROSS-REFERENCE TO RELATED APPLICATIONS

This application claims the benefit of the filing date under 35 U.S.C. § 119(a)-(d) of Japanese Patent Application No. 2018-181277, filed on Sep. 27, 2018, and Japanese Patent Application No. 2018-181276, filed on Sep. 27, 2018.

### FIELD OF THE INVENTION

The present invention relates to a seal member and, more particularly, to a seal member for an electrical connector or another electronic component.

### BACKGROUND

When an electrical connector is attached to a case of an electronic equipment, a seal member is sometimes disposed between the electrical connector and the case in order to prevent liquid ingress into the electronic equipment. Some seal members, such as that disclosed in Japanese Patent H8-315904A, have a lip formed along an extension direction of the seal member. The lip is brought into close contact with a contacted component, thereby improving waterproofness.

When the electrical connector is attached to the case with the seal member having the lip interposed therebetween, because the lip is pressed against the contacted component, a reaction force against a force in an attachment direction acts on the electrical connector. If the reaction force is small, close contact between the lip of the seal member and the contacted component is insufficient, and may result in a decrease in waterproofing created by the seal member. If the reaction force is large, a load to the electrical connector and a board on which the electrical connector is mounted is large.

### SUMMARY

A seal member includes a main body portion, an easily-deformable portion formed integrally with the main body portion and being more easily deformable than the main body portion, and a pair of lip portions. The lip portions are formed on an outer peripheral side of the seal member in a loading direction in which a compressive load elastically deforming the seal member acts.

### BRIEF DESCRIPTION OF THE DRAWINGS

The invention will now be described by way of example with reference to the accompanying Figures, of which:

FIG. 1A is a side view of a seal member according to an embodiment;

FIG. 1B is a perspective view of the seal member;

FIG. 2 is a sectional view of the seal member, taken along line II-II of FIG. 1A;

FIG. 3 is an enlarged side view of a plurality of ribs of the seal member;

FIG. 4 is a side view of the seal member and an electrical connector;

FIG. 5A is a bottom view of a connector assembly according to an embodiment;

FIG. 5B is a side view of the connector assembly;

FIG. 6A is a front view of the connector assembly and a case;

FIG. 6B is a perspective view of the connector assembly and the case;

FIG. 7 is a front view the connector assembly attached to the case;

FIG. 8 is a sectional view of a state of the seal member in the connector assembly;

FIG. 9 is a sectional view of a more deformed state of the seal member from FIG. 8;

FIG. 10 is a sectional view of a more deformed state of the seal member from FIG. 9;

FIG. 11A is a schematic view of the state of the seal member in FIG. 8;

FIG. 11B is a schematic view of the more deformed state of the seal member in FIG. 9;

FIG. 11C is a schematic view of a more deformed state of the seal member from FIG. 11B;

FIG. 11D is a schematic view of a more deformed state of the seal member from FIG. 11C; and

FIG. 12 is a graph of a relation between the deformation and reaction force of the seal member.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will convey the concept of the disclosure to those skilled in the art.

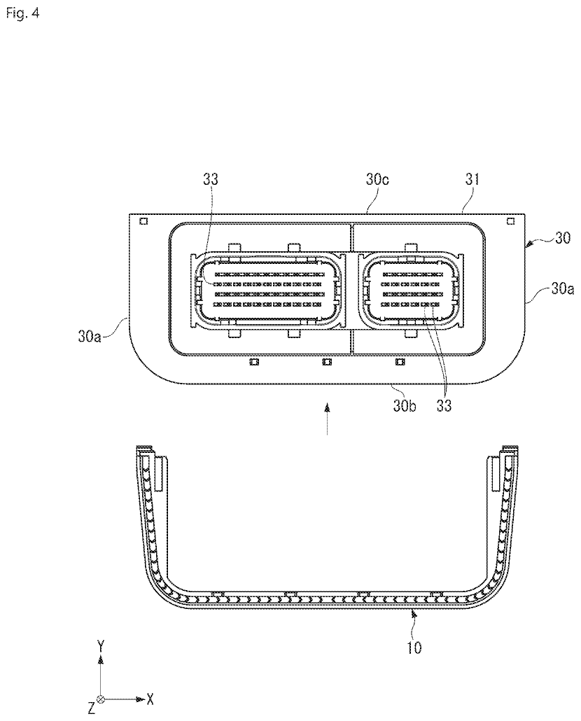

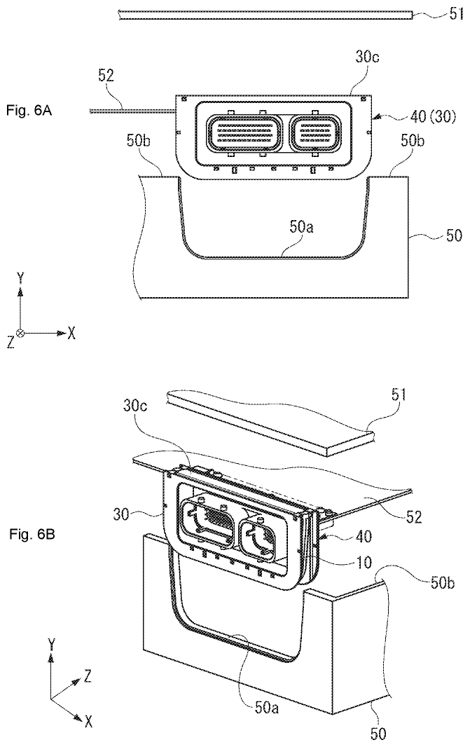

A seal member 10 according to an embodiment is used to prevent water ingress between an electrical connector 30, shown in FIG. 4, and a case 50 of an electronic equipment, shown in FIGS. 6A and 6B. A width direction X, a height direction Y, and a thickness direction Z of each element of the embodiments are defined as shown in the drawings. The seal member 10, as shown in FIGS. 4-6B, is attached over a side face portion 30a and a bottom face portion 30b of the electrical connector 30. As shown in FIG. 6B, the seal member 10 is disposed between the case 50 and the electrical connector 30 when the electrical connector 30 is attached to the case 50 of the electronic equipment.

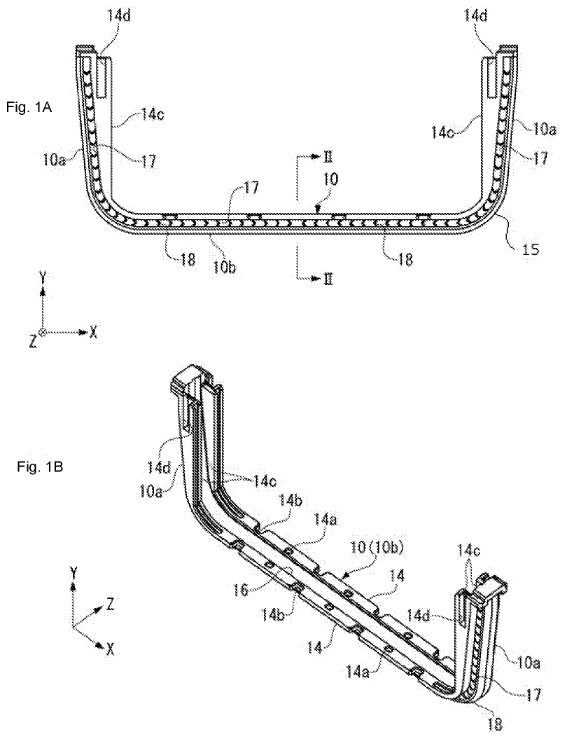

The seal member 10, as shown in FIGS. 1A and 1B, has a U-like shape opened on an upper side in the drawings. In an embodiment, the seal member 10 is a rubber member integrally formed by injection molding.

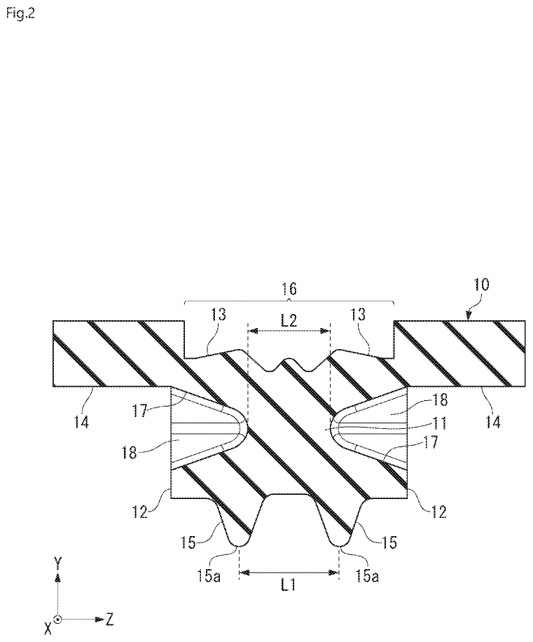

The seal member 10, as shown in FIG. 2, has a main body portion 11, a pair of first flange portions 12, a pair of second flange portions 13, a pair of projecting rim portions 14, and a pair of lip portions 15. The first flange portions 12 are formed on an outer peripheral side of the main body portion 11 (the lower side of FIG. 2) as to protrude from both side faces, respectively, of the main body portion 11. The second flange portions 13 are formed on an inner peripheral side of the main body portion 11 (the upper side of FIG. 2) as to protrude from both side faces, respectively, of the main body portion 11. The first flange portion 12 and the second flange portion 13 have a groove 17 therebetween, and are thereby set smaller in dimension in the height direction Y than the main body portion 11. That is, the first flange portion 12 and the second flange portion 13 are connected like a cantilever to the main body portion 11. The first flange portion 12 and the second flange portion 13 deform easily under a load in the height direction Y; the first flange portion 12 and the second flange portion 13 may be referred to as an easily-deformable portion.

The main body portion 11, as shown in FIG. 2, connects the first flange portion 12 on the outer peripheral side and the second flange portion 13 on the inner peripheral side vertically in the drawing. In the seal member 10, a portion composed of the main body portion 11, the first flange portion 12 and the second flange portion 13 has a substantially H-like shape rotated by 90 degrees in cross section. The main body portion 11 is larger in dimension in the height direction Y than the first flange portion 12 and the second flange portion 13. In the main body portion 11, for example, the deformation amount in compression direction is minute under substantially the same load in the height direction Y as compared to the first flange portion 12 and the second flange portion 13.

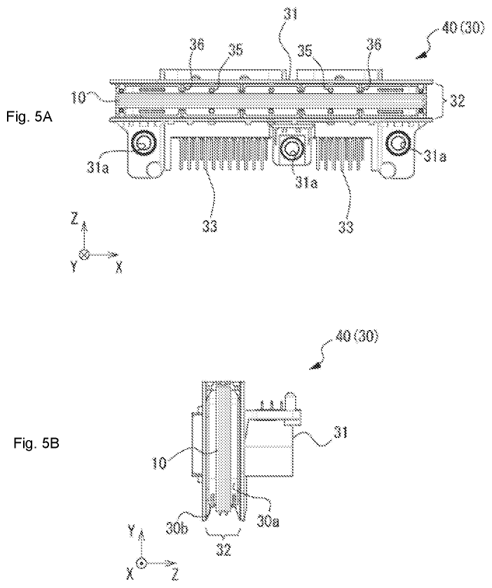

The projecting rim portions 14 are connected to both sides, respectively, of the second flange portions 13. In the projecting rim portion 14, as shown in FIG. 1B, receiving holes 14a and slits 14b are formed. The receiving hole 14a and the slit 14b, as shown in FIG. 5A, engage with a pin 35 and a projection 36, respectively, provided on the electrical connector 30, and function to align the seal member 10 with the electrical connector 30.

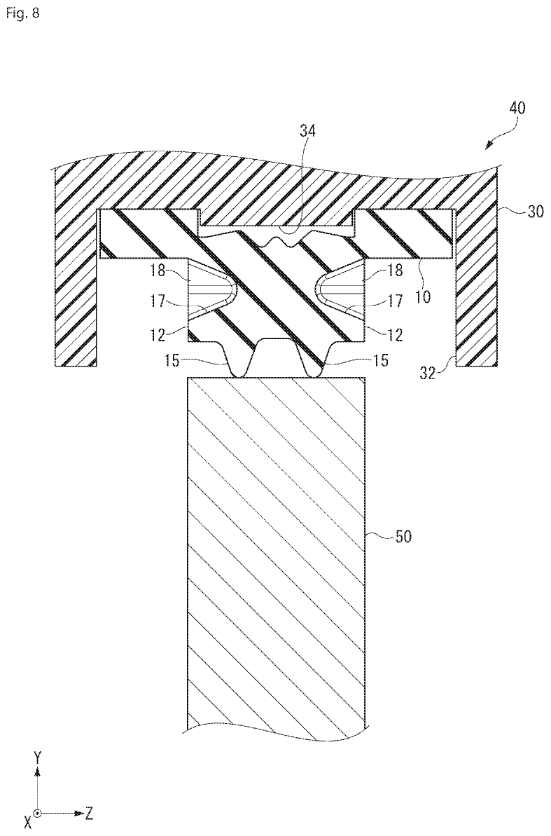

As shown in FIG. 1B, in a pair of arm portions 10a curved and extending in the height direction Y from both ends of a bottom portion 10b of the seal member 10, supporting walls 14c are formed from the respective projecting rim portions 14 in a direction toward the inner periphery. An engaging recess 16 having a C-like shape in cross section is formed in an inner peripheral face of the seal member 10. The engaging recess 16 faces the supporting walls 14c and the main body portion 11 in the arm portion 10a of the seal member 10, and faces the projecting rim portions 14 and the main body portion 11 in the bottom portion 10b of the seal member 10. An engaging protrusion 34, shown in FIG. 8 and described in greater detail below, disposed on an outer periphery of the electrical connector 30 is engaged in the engaging recess 16.

A guiding groove 14d extending along the height direction Y is formed in an outer face of the supporting wall 14c, as shown in FIGS. 1A, 1B and 4. The guiding groove 14d engages with a key, not shown, provided on the electrical connector 30. The guiding groove 14d guides the seal member 10 in the height direction Y that is an insertion/extraction direction when the seal member 10 is attached to the electrical connector 30, and also functions as a retainer so that the seal member 10 will not become detached in the width direction X from the electrical connector 30.

As shown in FIG. 2, the first flange portion 12 and the second flange portion 13 extend substantially parallel along the thickness direction Z, and protrude in the thickness direction Z more than the main body portion 11 from both the side faces of the main body portion 11. The groove 17 facing the first flange portion 12, the second flange portion 13, and the main body portion 11 and recessed in the thickness direction Z is formed in both side faces of the seal member 10. In the embodiment shown in FIG. 2, the groove 17 has a substantially V-like shape in cross section. In other embodiments, the cross section of the groove 17 may have another shape, for example, a C-like shape, a U-like shape, a semicircular shape, or the like.

When the bottom portion 10b of the seal member 10 is compressed in the height direction Y, the seal member 10 deforms such that the first flange portion 12 and the second flange portion 13 deflect toward the inside of the groove 17 to narrow the space of the groove 17 in the height direction Y. At this time, with the compression of the main body portion 11, a reaction force occurs in the height direction Y. In the arm portion 10a of the seal member 10, the compression direction is from the inner peripheral side of the seal member 10 toward the outer peripheral side thereof, and the seal member 10 is compressed to deform in the same manner as the bottom portion 10b. Therefore, in the arm portion 10a, the compression direction is not coincident with the height direction Y. Hereinbelow, regarding the compression of the seal member 10, the case of the bottom portion 10b will be described unless otherwise noted.

As shown in FIG. 1A, the groove 17 is formed along an extension direction of the seal member 10 from a first end to a second end of the seal member 10. In addition, a plurality of ribs 18 connected to the first flange portion 12 and the second flange portion 13 are positioned within the groove 17. The ribs 18 are positioned at a predetermined interval in the extension direction of the seal member 10. The ribs 18 adjust the reaction force in the height direction Y when the seal member 10 is compressed in the height direction Y. The rib 18 may also be referred to as a reinforcing portion.

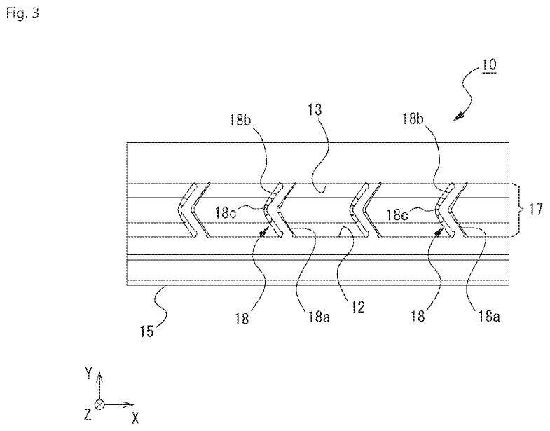

Each rib 18, as shown in FIG. 3, has a first element 18a and a second element 18b. A first end of the first element 18a is connected to the first flange portion 12, and a second end of the first element 18a is connected to a first end of the second element 18b. A second end of the second element 18b is connected to the second flange portion 13. The first element 18a is so positioned as to be inclined with respect to the height direction Y of the seal member 10, and the second element 18b is so positioned as to be inclined in a direction opposite to the first element 18a with respect to the height direction Y of the seal member 10. The first element 18a and the second element 18b are so connected together as to fold back in the middle in the height direction Y of the seal member 10. A portion connecting the second end of the first element 18a and the first end of the second element 18b is also referred to as bent portion 18c. The rib 18 is formed in a shape like a bent line in which the first element 18a and the second element 18b are bent and connected together. In other embodiments, the shape of the rib 18 is not limited to the shape like a bent line, but may have a curved shape, for example, an arc shape, or the like.

The rib 18 supports the first flange portion 12 and the second flange portion 13 with elasticity due to bending. When the first flange portion 12 and the second flange portion 13 deflect toward the inside of the groove 17, the first element 18a and the second element 18b deflect, thereby causing the rib 18 to exert the reaction force in the height direction Y.

Because the first element 18a and the second element 18b are each inclined with respect to the height direction Y, when the rib 18 receives a load in the height direction Y, the first element 18a and the second element 18b move easily. Therefore, when the seal member 10 is compressed in the height direction Y, with the deformation of the first flange portion 12 and the second flange portion 13 deflecting toward the inside of the groove 17, the rib 18 deforms such that an angle formed between the first element 18a and the second element 18b decreases gradually. Being bent, the rib 18 is more easily deformable than the first flange portion 12 and the second flange portion 13, thus not obstructing the deformation of the first flange portion 12 and the second flange portion 13.

The ribs 18, as shown in FIG. 1A, have bending directions of the ribs 18 in the arm portion 10a oriented uniformly in a clockwise direction from the end on the right side in the drawing of the seal member 10 toward the bottom portion 10b. In addition, from the end on the left side in the drawing of the seal member 10 toward the bottom portion 10b, bending directions of the ribs 18 in the arm portion 10a are oriented uniformly in a counterclockwise direction.

In the seal member 10, the arrangement of the ribs 18 on the left side of FIG. 1A and the arrangement of the ribs 18 on the right side of FIG. 1A are bilaterally symmetrical. Because the ribs 18 of the seal member 10 are in a bilaterally-symmetrical arrangement, the deformations of the first flange portion 12 and the second flange portion 13 in the right and left arm portions 10a are easily equalized.

When the seal member 10 is pressed into the case, the bottom portion 10b of the seal member 10 receives a compressive load from the height direction Y. On the other hand, extending along the height direction Y, the arm portion 10a of the seal member 10 receives a load in the extension direction of the seal member 10 when the seal member 10 is pressed in. The bending directions of the ribs 18 in the arm portion 10a are oriented uniformly from the end of the seal member 10 toward the bottom portion 10b. Therefore, in the arm portion 10a, the ribs 18 easily bend in a pressing direction of the seal member 10.

The arrangement of the groove 17 and the ribs 18 on one side face of the seal member 10, a front face side of the electrical connector 30, is shown in FIG. 1A. The arrangement of the groove 17 and the ribs 18 on another side face of the seal member 10, a back face side of the electrical connector 30, is also similar to that on the one side face.

The pair of lip portions 15, as shown in FIG. 2, are provided upright on an outer peripheral side, the lower side of FIG. 2, of the first flange portions 12, respectively, of the main body portion 11. As shown in FIG. 1A, the pair of lip portions 15 are formed along the extension direction of the seal member 10 from the one end to the other end of the seal member 10. In the shown embodiment, the cross section of each lip portion 15 has an isosceles-triangular shape, the base of which is connected to the first flange portion 12. In other embodiments, the cross section of the lip portion 15 is not limited to the isosceles-triangular shape, but may have another shape, for example, a scalene-triangular shape, or the like.

The lip portion 15 is supported by the first flange portion 12, and a vertex 15a of the lip portion 15, as shown in FIG. 2, is located in a region where the groove 17 is formed in the thickness direction Z. The vertex 15a of the lip portion 15 is located more externally than the main body portion 11 in the thickness direction Z. In the thickness direction Z, an interval L1 between the vertices 15a of the pair of lip portions 15 is set larger than a width L2 of the main body portion 11 (L1>L2).

When the seal member 10 is compressed in the height direction Y, the first flange portion 12 deflects toward the inside of the groove 17. In addition, the lip portion 15 supported by the first flange portion 12 deforms so as to fall toward the outside of the seal member 10. When the seal member 10 is compressed in the height direction Y, the pair of lip portions 15 deform so as to widen the interval between their distal ends.

In the shown embodiment, the electrical connector 30 is a male connector configured to be mated with a mating connector in the thickness direction Z that is a connector mating direction. As shown in FIGS. 6A and 6B, the electrical connector 30 is attached to an edge portion of a wiring board 52 mounted on the electronic equipment.

A housing 31 of the electrical connector 30 is integrally formed by injection molding of, for example, an electrically-insulating resin material (polybutylene terephthalate, or the like). In the housing 31, as shown in FIG. 5B, a seal retaining portion 32 for retaining the seal member 10 is formed over a side face portion 30a and a bottom face portion 30b of the electrical connector 30. A threaded hole 31a used for fixation to the wiring board 52 is provided in a back face of the housing 31.

The housing 31 of the electrical connector 30, as shown in FIGS. 4-5B, retains each of a plurality of male contacts 33 extending in the thickness direction Z. The male contact 33 is formed by stamping an electrically-conductive metal material, for example, a copper alloy sheet material. Each male contact 33 is led out from a front face side to a back face side of the housing 31, and electrically connected to a through-hole, not shown, of the wiring board 52 on the back face side.

Within the seal retaining portion 32, the engaging protrusion 34, shown in FIGS. 8-10, is formed along the extension direction of the seal retaining portion 32. In addition, the pins 35 for engaging with the receiving holes 14a and the projections 36 for engaging with the slits 14b are each formed within the seal retaining portion 32.

The seal member 10 can be attached to the seal retaining portion 32 of the electrical connector 30, as shown in FIG. 4, from the lower side in the drawing. In the shown embodiment, the electrical connector 30 having the seal member 10 attached thereto is also referred to as connector assembly 40.

The case 50, as shown in FIGS. 6A and 6B, is an enclosure opened on the upper face side in the drawings, and the wiring board 52 can be accommodated in the case 50. An upper face of the case 50 is closed with a lid 51. In an embodiment, the case 50 and the lid 51 are formed from a metal material, for example, an aluminum alloy, or the like. In other embodiments, the case 50 and the lid 51 may be formed by injection molding of a resin material.

As shown in FIGS. 6A and 6B, a notch 50a corresponding to the contour of the electrical connector 30 is formed in the case 50. This notch 50a has an inverted trapezoidal shape wider on an open-top side and narrower on a bottom side. When the wiring board 52 is accommodated into the case 50, the connector assembly 40 can be engaged with the notch 50a from the upper side of FIGS. 6A and 6B to expose the front face side of the electrical connector 30 outside the case 50. Between the connector assembly 40 and the notch 50a of the case 50, waterproofness is ensured by the seal member 10 attached to the electrical connector 30.

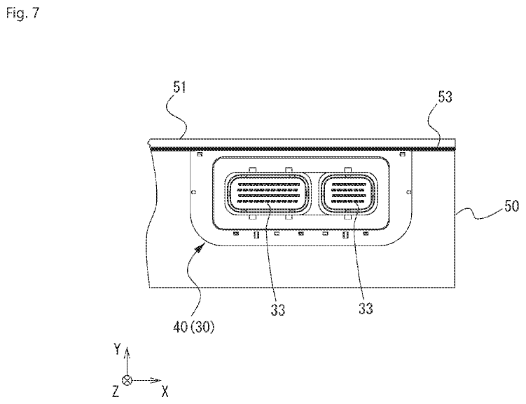

With the connector assembly 40 attached to the case 50, an upper face portion 30c of the electrical connector 30 engaged with the notch 50a and an upper face 50b of the case 50 are flush with each other. Though the seal member 10 is not positioned on the upper face portion 30c of the electrical connector 30, a waterproof layer 53 is formed by applying liquid gasket between the upper face portion 30c of the electrical connector 30, the upper face 50b of the case 50 and the lid 51, as shown in FIG. 7. This waterproof layer 53 ensures waterproofness between the upper face portion 30c of the electrical connector 30 and the lid 51 and between the upper face 50b of the case 50 and the lid 51.

In assembly of the electronic equipment, as shown in FIGS. 6A-7, the wiring board 52 is positioned within the case 50. The connector assembly 40 attached to the wiring board 52 is inserted into the notch 50a of the case 50. The shape of the notch 50a is an inverted trapezoidal shape wider on the open-top side and narrower on the bottom side. Therefore, without interference of the seal member 10 of the connector assembly 40 with the open top of the notch 50a, the electrical connector 30 can be inserted into the notch 50a. Thereby, the connector assembly 40 can be easily positioned in the notch 50a.

When the connector assembly 40 is positioned in the notch 50a of the case 50, the lip portion 15 of the seal member 10 comes into contact with the case 50. In this state, excluding the self-weight of the connector assembly 40, a force is not applied to the seal member 10 from the upper side in the drawing. Therefore, in the bottom face portion 30b of the electrical connector 30, the pair of lip portions 15 keep their shapes upright along the height direction Y, as shown in FIG. 8.

Next, the liquid gasket waterproof layer 53 is applied to the upper face portion 30c of the electrical connector 30 and the upper face 50b of the case 50 as shown in FIG. 7. Thereafter, the lid 51 is attached to the case 50. When the lid 51 is attached to the case 50, the connector assembly 40 is pressed by the lid 51 into the notch 50a. Thereby, in the bottom face portion 30b and the side face portion 30a of the electrical connector 30, the seal member 10 deforms in the following manner.

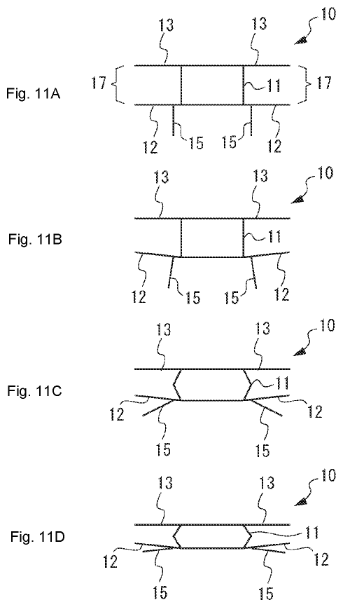

The course of deformation of the seal member 10 in the bottom face portion 30b of the electrical connector 30 is schematically shown in FIGS. 11A-11D.

FIG. 11A shows an initial state in which the seal member 10 has not been compressed. The state shown in FIG. 11A corresponds to FIG. 8. Since being thinner in dimension in the thickness direction Z than the main body portion 11, each lip portion 15 deflects more easily than the main body portion 11. In addition, the lip portion 15 is supported by the first flange portion 12 having a smaller dimension in the thickness direction Z than the main body portion 11 due to the formation of the groove 17. As described above, the first flange portion 12 deflects to deform more easily than the thicker main body portion 11. Moreover, the vertex 15a of the lip portion 15 is located more externally than the main body portion 11 in the thickness direction Z.

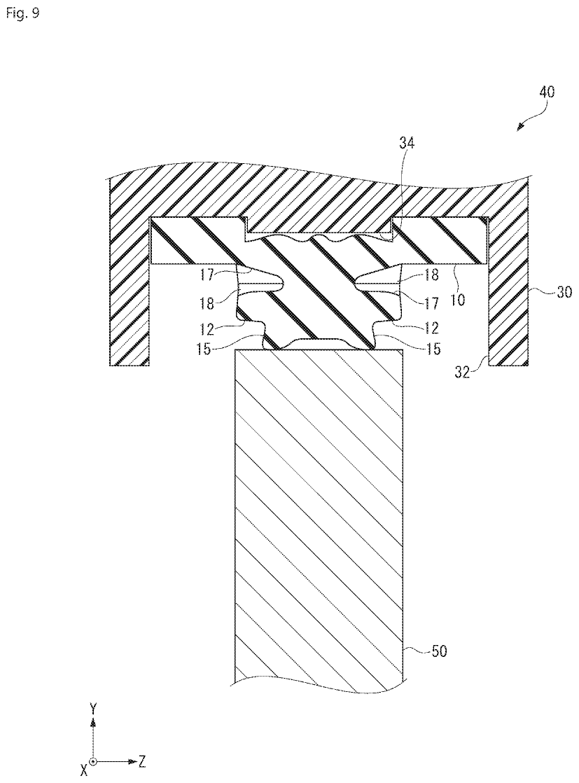

When the seal member 10 is compressed in the height direction Y, the lip portions 15 in contact with the case 50 deform elastically so as to separate their distal ends contacting the case 50 from each other, that is, to spread outward, and start to incline, as shown in FIG. 9 and FIG. 11B. The first flange portion 12 receives a load in conjunction with inclination of the lip portion 15, and therefore deflects slightly toward the inside of the groove 17. At this time, the main body portion 11 undergoes little, if any, compressive deformation.

Then, as the seal member 10 further receives the load in the height direction Y, the deformation progresses such that the lip portion 15 inclines further to fall down, as shown in FIG. 11C. In this manner, as the displacement of the electrical connector 30 toward the case 50 increases, the interval between the distal ends of the lip portions 15 becomes wider.

In addition, as the displacement of the case 50 further increases, the deflection of the first flange portion 12 and the second flange portion 13 reaches the limit, and the deformation of the lip portions 15 also reaches the limit, as shown in FIG. 11D. Thereupon, compressive deformation occurs in the main body portion 11, and a reaction force of the seal member 10 due to the main body portion 11 occurs.

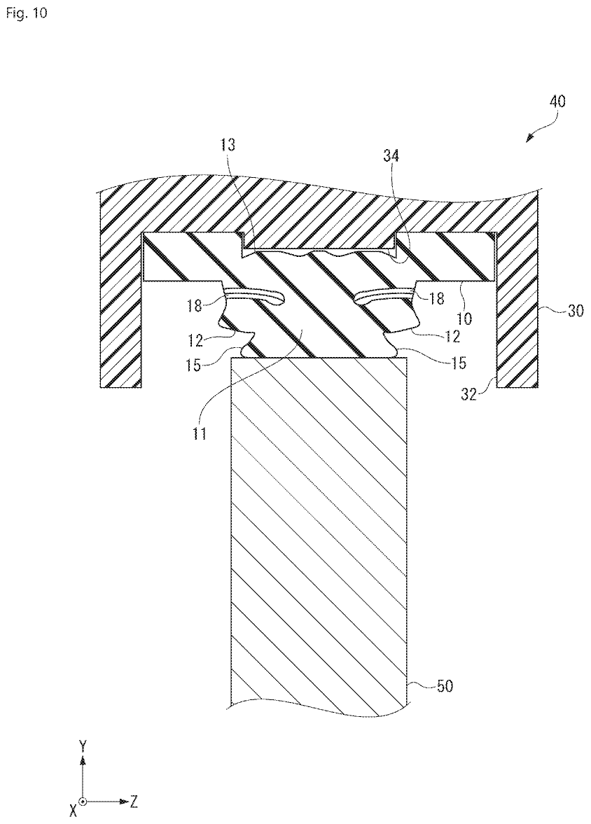

FIG. 10 shows a state in which the first flange portion 12 and the second flange portion 13 are in contact with each other and the deflection of the first flange portion 12 and the second flange portion 13 has reached the limit. In the state shown in FIG. 10, the dimension in the height direction Y of the main body portion 11 is larger than the combined dimension in the height direction Y of the first flange portion 12 and the second flange portion 13. Therefore, when the electrical connector 30 is so displaced as to approach the case 50, the main body portion 11 receives a load due to this displacement to undergo compressive deformation. This causes both the pair of lip portions 15 of the seal member 10 to spread outward and contact the case 50, and causes the second flange portion 13 of the seal member 10 to come into contact with the engaging protrusion 34 of the connector assembly 40. At this time, the compressive deformation of the main body portion 11 in the height direction Y causes the lip portion 15 to come into close contact with the case 50, and causes the second flange portion 13 to come into close contact with the engaging protrusion 34. Thereby, waterproofness between the case 50 and the electrical connector 30 is ensured.

Next, the deformation of the seal member 10 in the side face portion 30a of the electrical connector 30, shown in FIG. 4, will be described.

When the seal member 10 is pressed from the upper side in the drawings, the seal member 10 moves toward the lower side in the drawings, and thereby a space between the seal member 10 and the notch 50a, shown in FIGS. 6A and 6B, becomes small in the side face portion 30a of the electrical connector 30. Thereby, the seal member 10 is also pressed to the notch 50a in the side face portion 30a of the electrical connector 30, and thus the seal member 10 deforms in the same manner as the bottom face portion 30b. When the seal member 10 is pressed into the case 50, the bottom portion 10b of the seal member 10 receives the compressive load from the height direction Y. On the other hand, by extending along the height direction Y, the arm portion 10a of the seal member 10 receives a load from the extension direction of the seal member 10 when the seal member 10 is pressed in.

The ribs 18 of the seal member 10 have bending directions oriented uniformly from the end of the seal member 10 toward the bottom portion 10b. That is, in the side face portion 30a of the electrical connector 30, each rib 18 easily bends in the downward direction in the drawings that is a direction in which the seal member 10 is pressed in. In the side face portion 30a of the electrical connector 30, the direction in which the ribs 18 easily bend and the direction in which the seal member 10 is pressed in are coincident with each other, so that the ribs 18 of the arm portion 10a easily bend when the seal member 10 is pressed in.

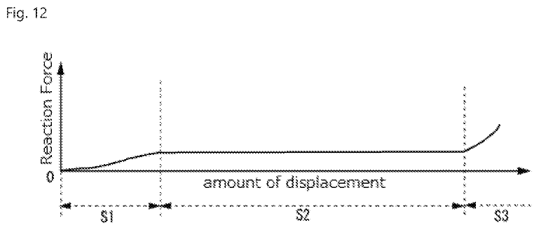

With reference to FIG. 12, a relation between the deformation and reaction force of the seal member 10 will be described. The vertical axis of FIG. 12 indicates the load (reaction force) when the seal member 10 is compressed in the height direction Y, and the horizontal axis of FIG. 12 indicates the amount of displacement in the height direction Y of the seal member 10 after the case 50 comes into contact with the lip portions 15.

The seal member 10, as shown in FIG. 12, develops an initial elastic region S1 where the reaction force increases proportionally with respect to the amount of displacement, an intermediate region S2, following the initial elastic region S1, where the reaction force hardly increases with respect to the amount of displacement, and a late elastic region S3, following the intermediate region S2, where the reaction force increases proportionally with respect to the amount of displacement.

In the initial elastic region S1, with the displacement of the case 50 after the case 50 comes into contact with the distal ends of the lip portions 15 in the seal member 10, the lip portions 15, the first flange portions 12 and the second flange portions 13 undergo the deformation described above. The initial elastic region S1 corresponds to, for example, FIGS. 11A and 11B.

The intermediate region S2 is a range within which the deformation of the lip portions 15, the first flange portions 12 and the second flange portions 13 further progresses, for example, until the amount of deformation reaches the limit after the first flange portions 12 and the second flange portions 13 come into contact with each other. In this period, regardless of an increase in the amount of displacement of the case 50, the reaction force of the seal member 10 hardly increases, since the lip portions 15, the first flange portions 12 and the second flange portions 13 deform very easily.

In the late elastic region S3, after the deformation of the first flange portions 12 and the second flange portions 13 reaches the limit, further displacement of the case 50 causes a reaction force in the main body portion 11. This reaction force of the main body portion 11 increases in proportion to the amount of displacement in the height direction Y of the case 50.

In this regard, the magnitude of the reaction force in each region is determined by the material of the seal member 10 and/or the shape and dimensions of the rib 18. In particular, in the region S2, the compression of the main body portion 11 and the rib 18 causes the reaction force. For example, in order to increase the reaction force in the region S2, the number of ribs 18 may be increased or each rib 18 may be thickened. In order to decrease the reaction force in the region S2, the number of ribs 18 may be reduced or each rib 18 may be thinned. In this manner, in the present embodiment, by adjusting the shape and dimensions of the rib 18 of the seal member 10, the reaction force of the seal member 10 can be easily adjusted without changing the material of the seal member 10.

In the seal member 10, the lip portions 15, the first flange portion 12, and the second flange portion 13 deform ahead of the main body portion 11 after the lip portions 15 come into contact with the case 50 and until the deformation of the first flange portion 12 and the second flange portion 13 reaches the limit. Because the lip portions 15, the first flange portion 12 and the second flange portion 13 of the seal member 10 are easily deformable, the reaction force that occurs in the seal member 10 is small. Therefore, a force required for the work of attaching the connector assembly 40 to the case 50 is reduced.

After the deformation of the first flange portion 12 and the second flange portion 13 reaches the limit, the main body portion 11 undergoes elastic deformation in place of the lip portions 15, the first flange portion 12, and the second flange portion 13, and exerts the reaction force. Because it is not easily elastically deformable, the main body portion 11 exerts a larger reaction force than the lip portions 15. Thereby, the waterproof performance of the seal member 10 can be ensured.

The ribs 18 receiving the compressive load are formed between the first flange portion 12 and the second flange portion 13. Because the first flange portion 12 and the second flange portion 13 are supported by the ribs 18 and thereby exert the reaction force, the reaction force of the seal member 10 can be compensated by the ribs 18. While being bent, the ribs 18 are more easily deformable than the first flange portion 12 and the second flange portion 13, and therefore do not obstruct the deformation of the first flange portion 12 and the second flange portion 13. In addition, fine adjustment of the magnitude of the reaction force that occurs in the seal member 10 can also be made by the shape and dimensions of the rib 18.

The pair of lip portions 15 are supported by the first flange portions 12, respectively, each protruding from both sides on the outer peripheral side of the main body portion 11. Furthermore, the vertices 15a of the pair of lip portions 15 in cross section are located more externally than the main body portion 11. Therefore, in the thickness direction Z, the interval L1 between the vertices 15a of the lip portions 15 is set larger than the width L2 of the main body portion 11 (L1>L2). This causes the lip portion 15 to deform so as to fall outward with the deflection of the first flange portion 12 when a force is applied to the lip portions 15, so that the pair of lip portions 15 can be so deformed as to widen the interval between their distal ends.

The seal member 10 of the present embodiment has a U-like overall shape, and is attached to the bottom face portion 30b and the side face portion 30a of the electrical connector 30. In assembly of the electronic equipment, the elastic deformation of the seal member 10 can absorb a dimensional tolerance in the width direction W or the height direction Y of the connector assembly 40 and the notch 50a.

The seal member 10 is attached to the bottom face portion 30b and the side face portion 30a of the electrical connector 30. In assembly of the electronic equipment, the seal member 10, which exerts a reaction force, is not provided on the upper face portion 30c of the electrical connector 30 that is a face to be contacted with the lid 51. A condition when the lid 51 is attached to the upper face portion 30c of the electrical connector 30 and a condition when the lid 51 is attached to the upper face 50b of the case 50 can be made uniform, so that the working efficiency in assembling the electronic equipment can be improved.

The description in the above embodiment may be selectively adopted and/or eliminated or, if appropriate, may be modified to another configuration unless such selective adoption and/or elimination departs from the gist of the present invention.

For example, in the above embodiment, the illustrative configuration has been described in which the seal member 10 is attached to the electrical connector 30, but the seal member 10 may be attached to the case 50. In addition, the lip portion 15 of the seal member 10 may be provided on a face to be attached to the electrical connector 30. In addition, in the above embodiment, the ribs 18 may not be provided in the groove 17 of the seal member 10.

In the above embodiment, the distal end of the lip portion 15 may be so formed preliminarily as to be inclined outward. In this case, without the vertex of the lip portion 15 located more externally than the main body portion 11, the lip portion 15 can be so deformed as to incline outward.

In the above embodiment, the example has been described in which the easily-deformable portions are provided by providing the groove 17 in both sides (both ends) in the thickness direction Z of the main body portion 11. However, the easily-deformable portion of the present invention is not limited to the above embodiment as long as it is composed of a portion thinner than the main body portion. For example, a groove may be provided in the center in the thickness direction Z of the main body portion 11 so that the pair of lip portions 15 can be inclined inward. In this case, the main body portion corresponds to a main body portion 11 which is solid on both sides (both ends) in the thickness direction Z.

What is claimed is:

1. A seal member, comprising:
a main body portion;
an easily-deformable portion formed integrally with the main body portion and being more easily deformable than the main body portion; and
a pair of lip portions formed on an outer peripheral side of the seal member in a loading direction in which a compressive load elastically deforming the seal member acts.

2. The seal member of claim 1, wherein the easily-deformable portion includes a first flange portion protruding from a first side face of the main body portion.

3. The seal member of claim 2, wherein the first flange portion is thinner in the loading direction than the main body portion.

4. The seal member of claim 3, wherein a pair of vertices of the lip portions are located more externally than the main body portion in the loading direction.

5. The seal member of claim 4, wherein an interval between the vertices is larger than a width of the main body portion.

6. The seal member of claim 3, wherein the easily-deformable portion includes a second flange portion protruding from a second side face of the main body portion.

7. The seal member of claim 6, further comprising a rib connected to the first flange portion and the second flange portion.

8. The seal member of claim 1, wherein the seal member has an overall U-like shape.

9. A seal member, comprising:
a main body portion;
an easily-deformable portion formed integrally with the main body portion and being more easily deformable than the main body portion; and
a rib more easily deformable than the easily-deformable portion and supporting the easily-deformable portion.

10. The seal member of claim 9, further comprising a plurality of ribs formed at an interval in an extension direction of the seal member.

11. The seal member of claim 10, wherein the easily-deformable portion includes a first flange portion protruding from a first side face of the main body portion and a second flange portion protruding from a second side face of the main body portion.

12. The seal member of claim 11, wherein the ribs connect the first flange portion and the second flange portion.

13. The seal member of claim 12, wherein the first flange portion and the second flange portion are thinner than the main body portion in a loading direction in which a compressive load acts than the main body portion.

14. The seal member of claim 9, wherein the rib supports the easily-deformable portion with an elasticity based on a bending of the rib.

15. The seal member of claim 9, wherein the rib has a bent shape.

16. The seal member of claim 15, wherein the seal member has a U-like shape with a bottom portion and a pair of arm portions each connected to the bottom portion.

17. The seal member of claim 16, wherein the rib has a bending direction oriented from an end of the arm portions toward the bottom portion.

18. The seal member of claim 9, further comprising a pair of lip portions formed on an outer peripheral side of the seal member in a loading direction in which a compressive load elastically deforming the seal member acts.

19. A connector assembly, comprising:
an electrical connector; and
a seal member attached to the electrical connector, the seal member including:
a main body portion;
an easily-deformable portion formed integrally with the main body portion and being more easily deformable than the main body portion; and
a pair of lip portions formed on an outer peripheral side of the seal member in a loading direction in which a compressive load elastically deforming the seal member acts, or a rib more easily deformable than the easily-deformable portion and supporting the easily-deformable portion.
